(19) United States
(12) Patent Application Publication
(10) Pub. No.: US 2009/0286210 A1
(43) Pub. Date: Nov. 19, 2009

(54) Methods and Systems for Providing Interactive Content

(75) Inventors: Kimberly Spreen, Atlanta, GA (US); Jesse Smith, Atlanta, GA (US); Kevin Huang, Atlanta, GA (US); Mary Frances Jones, Decatur, GA (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Fuzzy Logic, Atlanta, GA (US)

(21) Appl. No.: 12/355,071

(22) Filed: Jan. 16, 2009

Related U.S. Application Data
(60) Provisional application No. 61/079,527, filed on Jul. 10, 2008.
(60) Provisional application No. 61/127,632, filed on May 14, 2008.

(51) Int. Cl. G09B 21/00

(52) U.S. Cl. 434/112; 434/308

(57) ABSTRACT

Embodiments of the invention provide an interactive system that can receive input and present content in an interactive manner.

### RELATED APPLICATIONS

This application claims the benefit of U.S. Provisional patent application No. 61/127,632 filed, on May 14, 2008 and U.S. Provisional patent application No. 61,079,527, filed on Jul. 10, 2008.

### FIELD OF THE INVENTION

This invention relates generally to interactive content presentation. In one embodiment, it relates to providing an interactive system that can recognize a code associated with an object or image and display an output related to that object or image. More specifically, certain embodiments provide systems and methods for providing interactive sign language or other types of instruction. Specific embodiments may use radio frequency identification of objects or images and coordinate the identification of the objects or images with a corresponding output, such as a demonstration of a sign language representation of the object or image.

### BACKGROUND

Children enjoy and learn from a variety of interactive toys. Toys that play recorded sounds or speech when a child pushes certain buttons are popular. In one example, a toy may contain 26 buttons—one for each letter of the alphabet—and play a recorded sound representing a corresponding letter when one of the buttons is pushed. Current methods for receiving input in such toys are limited. Typically, children need to physically push a button on the toy. To do so requires a certain amount of dexterity and precision and limits the use of the toy to circumstances in which the toy is within arm's reach. The toy interface also typically limits the play/learning experience to one child at a time and does not mimic visual interaction with an environment. Generally, toys are not able to “recognize” objects or images within the toy environment in a manner that more closely imitates the way a person would recognize an object or image by observing it with their eyes. Accordingly, improved methods for interacting with toys for enjoyment and learning are needed.

### BACKGROUND

Embodiments described herein relate to an interactive system or toy that can provide a number of different learning experiences. One particular use is in connection with sign language learning and acquisition for deaf children. The below summary describes specific reasons why and how such an interactive toy or system would be useful in this context. It is understood, however, that a number of contexts are equally applicable, such as interactive systems used to help teach other educational concepts or to help train the special needs adult population.

Sign language instruction benefits from an interactive environment in which the proper movement for various gestures can be easily seen. Students often have a difficult time learning how to express a sign language representation of a concept without being able to see the various movements and gestures that make up the sign. For example, pictures shown in a book of the sign language movement to be made (depicted in various stages of the sign) next to the object represented does not allow for interaction. It also makes it difficult to actually see how the movements of the sign should be made. Existing methods of providing interactive sign language instruction include toys such as those described in U.S. Pat. No. 4,799,889, which allow an instructor to put her arms inside of a toy and thereby carry out sign language gestures with the toy. Existing methods do not, however, provide an automated interactive instruction device that can help teach students sign language (or any other skill) by providing dynamic depiction of gestures, such as sign language gestures. Existing methods also fail to provide such gestures in an interactive way that imitates the way a person would naturally perceive objects in its environment.

One reason this type of instruction is important is because the field of deaf education research suggests that without the natural, immersive exposure to language that hearing affords most children from infancy, deaf children often arrive at school with a significant gap in language development which is difficult to bridge and often persists into adolescence and even adulthood. However, this pattern does not hold true for deaf children born to deaf parents, whose language acquisition typically follows a much more normal development cycle, because the child is immersed in a native language (often American Sign Language, “ASL”) from birth. This finding suggests that language acquisition is delayed not by deafness per se, but by an atypical language learning environment in which the parents do not know sign language, so the child is exposed to little or no language at all until beginning school.

The introduction of a deaf child into a hearing family presents a unique set of challenges. While some parents and siblings may learn some form of sign language early on, it is a difficult and demanding undertaking for everyone, especially adults. When sign language is used in the home, it is often limited to particular applications or scenarios. As a result, interactions between deaf children and their hearing family members tend to be shorter and plagued by more miscommunication and frustration than those between hearing-matched dyads.

If robust language exposure, whether English or ASL, is the key to developing language-related skills throughout childhood and also later in life, then deaf children must be directly and repeatedly presented with signs, words and language concepts to minimize language development delays. Early intervention programs, which typically take place between birth and entrance into formal school, have a two-fold effect on the progress of deaf children. First, they expose the child to language at the earliest point possible, vastly improving their language outcome at five years of age. Second, they engage parents in the learning process from the start. Parents who get involved early often communicate more effectively with their deaf child and have more impact on the child's progress throughout their development.

Any educational tool that can be introduced into the home environment to expose preschool deaf children to language can be effective as part of an early intervention program. Embodiments of the present invention can be used to address this important need.

Additionally, because of the limited commercial opportunity, only a limited number of ASL learning tools for deaf children are currently available in the market. Most tools are software-based and fall into two categories: rote memory programs, such as Con-SIGN-tration, and story oriented programs such as ASL Tales and Games. There are two general weaknesses observed in existing systems. The first is limited scalability—the games' inventory of words and signs is quickly depleted and the child can quickly lose interest. The second is a lack of user-directed interaction—most systems involve either one way instruction or indirect manipulation via a mouse, an interaction schema which may be somewhat limited in terms of accessibility, learnability and engagement.

As referenced above and as described in more detail below, embodiments of this invention also have applicability to a number of other learning modes. For example, some children (e.g., those who are visual learners) may learn math functions such as addition, subtraction, multiplication and division better in an interactive visual environment, as opposed to from a textbook or workbook. Further learning modes in which interaction can be beneficial are for learning numbers, shapes, colors, a foreign or second language, and so forth. For the sake of efficiency and convenience, examples will be focused on deaf children learning sign language, but it is understood that there are other possible learning modes that are intended to be encompassed within the scope of this invention.

### BRIEF DESCRIPTION OF THE DRAWINGS

FIG. 1 shows an exemplary interactive system according to one embodiment of the present invention.

FIG. 2 shows an alternate embodiment of an interactive system.

FIG. 3 shows one embodiment of a series of object representations in the form of flashcards for use with an interactive system.

FIG. 4 shows one embodiment of an output display for use in connection with an interactive system.

FIG. 5 shows one embodiment of connection mechanisms and an input receiver for use in connection with an interactive system.

FIG. 6 shows one embodiment of an input receiver for use in connection with an interactive system.

FIG. 7 shows one embodiment of the inside of an interactive system, prior to assembly.

FIG. 8 shows a flowchart of one embodiment of use of the interactive system.

FIG. 9 shows another flowchart of one embodiment for use of the interactive system.

FIGS. 10a-d show various embodiments for a code associated with an object representation.

### DETAILED DESCRIPTION

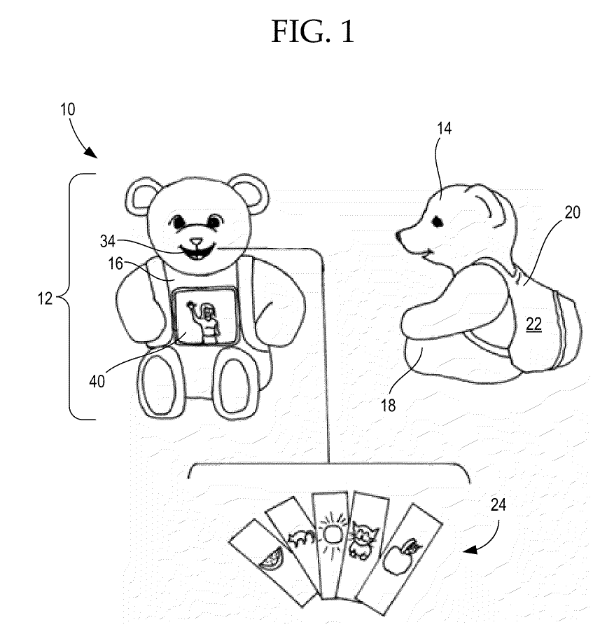

Embodiments of the present invention provide systems, methods, and devices for interactive content presentation. In one embodiment, there is provided an interactive system or object that can recognize an object or image and display an output related to that object or image. For example, FIG. 1 shows an interactive system 10 in the form of a stuffed animal teddy bear toy. It should be understood that any form for the toy or object may be used, including but not limited to other animal forms (a frog, pig, cow, caterpillar, and so forth), shapes, toys (a drum, book, ball, and so forth) or any other appropriate form (a video game screen). For the purposes of this description, interactive system 10 is shown as a teddy bear, but this reference is not intended to be limiting in any way.

Interactive system 10 has a body 12, an input receiver 32, and an output display 40. The body 12 may be in the form of a toy that a child can bond with and take anywhere the child goes, such as a stuffed animal or other cuddly creature, shape, or toy. Body 12 may alternatively be a flat screen, such as a video game or any other appropriate medium with which a child or other person can interact. In the embodiment shown in FIG. 1, body 12 has a head 14, a chest 16, and feet 18. There may also an optional storage pack 20 associated with body 12, which in FIG. 1 is shown as a backpack 22. In one embodiment, optional backpack 22 may be used to store object representations.

Interactive system 10 is also provided with one or more object representations 24. As shown in FIGS. 1-3, object representations 24 may be flashcards 26, which have an image 28 on the card 26. The term “image” is used to refer to a visual image of any object, and may be a drawing or a photograph, or any other image such as written words, numbers, colors, designs, shapes, a raised texture (such as braille), or any other object or concept that lends itself to being taught in an interactive way. In short, the image 28 may be anything that is desired to be a part of an input to system 10. In various embodiments, images 28 may depict fruits, vegetables, other food items, animals, colors, letters, numbers, shapes, clothing items, household objects, pronouns, connectors, cities, states, and so forth. In a specific flashcard embodiment, the flashcards 26 may be laminated or otherwise treated to ensure durability during rough play. “Flashcards” may also be made of plastic, foam, or other more durable material to prevent their damage during heavy play and use. In a further embodiment, replacement flashcards or flashcards relating to new modules may be downloaded and printed from a home computer. The interactive system 10 may also be sold with separate plastic pockets adapted to house and protect home-printed flashcards. Although object representations 24 may be images on a card, the representative word 29 may also be printed on the flashcard 26 in order to help teach reading as well.

It is also possible for object representations 24 to take the actual form of the object they represent (e.g., be formed in the shape of a piece of fruit, an animal, a letter, a number, and so forth). Combinations of various types of object representations 24 may also be provided.

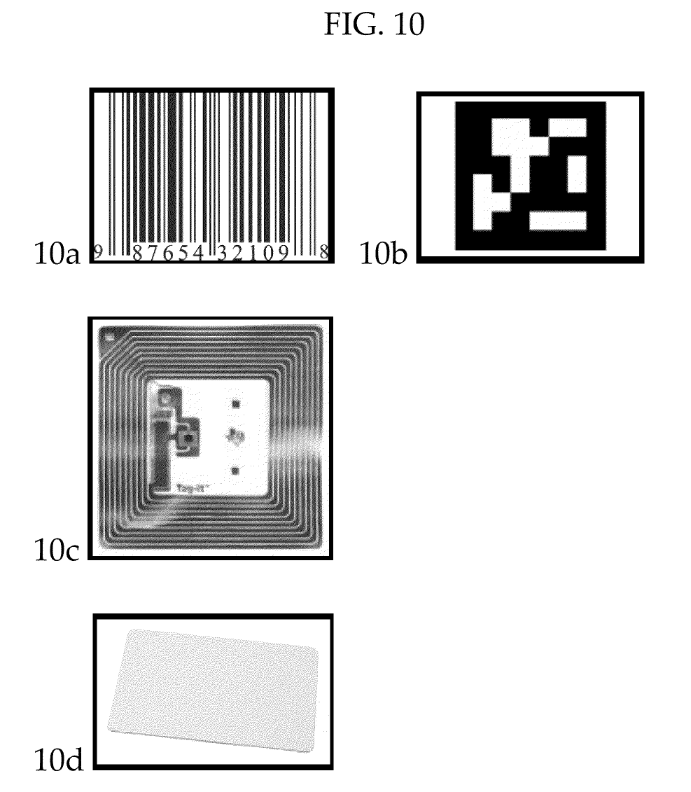

Whatever form that object representations 24 take, they should have a code 30 associated therewith, such that they can be recognized by input receiver 32. Code 30 may be an RFID (radio frequency identification) tag, a bar code, a series of numbers and/or letters, a series of holes, or any other appropriate code that can be recognized by input receiver 32, examples of which are shown in FIGS. 10a-10d. (FIG. 10a shows a bar code, FIG. 10b shows a fiducial, FIG. 10c shows an RFID tag, and FIG. 10d shows another embodiment of an RFID tag.)

Code 30 may alternatively be an array of reference points or fiducials (not shown) that can be visually recognized by input receiver 32. Examples of such configurations are used in connection with computer aided surgery methods.

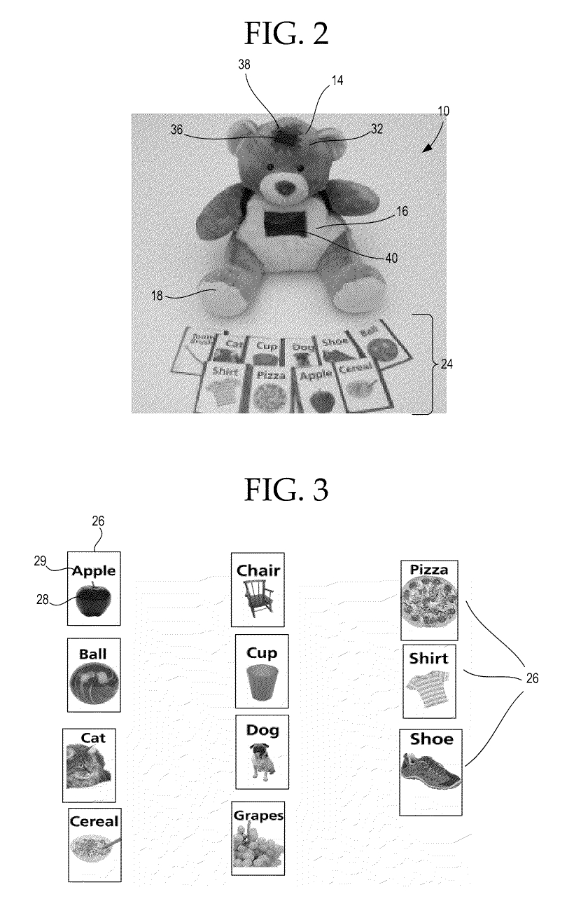

As described above, body 12 also has an input receiver 32. Input receiver 32 may be any feature that can read and recognize code 30 on object representations 24. For example, as shown in FIG. 1, input receiver 32 may be a card reader slot 34, and object representations 24 may be cards that can be inserted into card reader slot 24. As shown in FIG. 1, card reader slot 34 may be positioned on the toy's head 14, and may specifically be incorporated into its mouth. In another embodiment, input receiver may be an RFID reader 36 and object representations 24 may take any form that can be touched to the RFID reader 36. An RFID tag, which consists of a microchip and antenna, can be used to transmit identification information to the reader, which converts the radio waves from the RFID tag into digital information which is then processed by a microprocessor. As shown in FIG. 2, RFID reader 36 may be positioned on the toy's head 14, or may be incorporated into a hat or a hair bow or other decorative feature on the body 12.

In another embodiment, the RFID reader 36 can be placed inside the system (such as inside the head 14 or feet 18 or anywhere appropriate) with a patch or target 38 attached to the outside of the system 10 or toy to show the child where to present the object representation 24. The RFID reader may have a close range (e.g., 3-5 inches), so that the child can either “show” the representation 24 to the system 10 or touch it to the target 38 in order to achieve interaction, although further ranges are also possible, for instances when the child is not within arm's reach of the system. In certain embodiments, in order to best mimic vision in the system, it is possible to set the range of the RFID reader to recognize codes on object representations presented in the general vicinity of the toy's “face.” In a specific embodiment, an LED can be placed in the center of the target 38 to aid recognition of a successful interaction. The reader and optional LED can be connected to a microcontroller, which is connected to the output display 40.

Once input receiver 32 has recognized a code 30 on object representation 24, it accesses a database of video content stored in the system's memory. Various pieces of video content are associated with the various object representations 24 provided. The system may have various modes, such as “learn mode,” “quiz mode,” and/or “game mode.” For example, if one of the object representations 24 provided with interactive system 10 is an “apple,” then at least one item of video content should be associated with an apple. In the sign language teaching embodiments of this invention, the video content could be a video of a person gesturing the sign language word for “apple.” In “learn mode,” the user can show the object representation 24 of the apple to the system, and the system will access video content of a person gesturing the sign language word for “apple.” In “quiz mode,” the system can prompt the user with a question (e.g., using the video content, such as a person gesturing the sign language question: “Where is the apple?”), and then waits for the user to present the object representation 24 associated with the answer (e.g., the “apple” card or object representation 24). The “quiz mode” can be a valuable aspect of the system because it provides a self-grading mechanism and gives positive feedback for correct responses. Another option is to provide a “game mode” that includes other activities such as a memory game with multiple questions/signs to which the user is asked to identify multiple object representations 24. These examples are provided for illustration only; any number of interactive content may be accessed using the systems described herein.

In another embodiment, if one of the object representations 24 provided with interactive system 10 is a math equation (i.e., 2+2), then at least one item of video content should be associated with that math equation. In the math teaching embodiments of this invention, the video content could be the number “4” and/or a video showing four objects being placed side by side and/or someone counting “1, 2, 3, 4.” (In this embodiment, it is also possible for the output display to present the “answer” to the equation, requiring the child to then identify equations that would provide the “answer” and present them to the input receiver 32. For example, there may be flashcards that read “2+2”, “5−1” and “3+1”.) Further, if one of the object representations 24 provided with interactive system 10 is a “red circle,” in the foreign language mode, at least one item of video content should be associated with a foreign language equivalent of a red circle, such as someone saying “círculo rojo.” (It would be possible to switch between different languages or to download and/or insert different modules having various languages into the system.) These examples are provided merely to demonstrate the broad learning options and modes that can be used in connection with embodiments of the interactive system 10 described herein and are intended to be illustrative and not limiting. It is expected that various game and teaching modes for various different types of learning exercises can be sold or downloaded separately in order to provide a number of different learning scenarios.

Once the video content is accessed, the content is displayed on an output display 40. As shown in FIGS. 1 and 2, output display 40 may be on chest 16 of body 12. In one embodiment output, display 40 is an embedded LCD screen. Other options for output display 40 include but are not limited to TFT displays, personal communication devices, such as a blackberry or cell phone, or any other screen or device having an associated screen. Output display 40 may also have an audio component associated therewith.

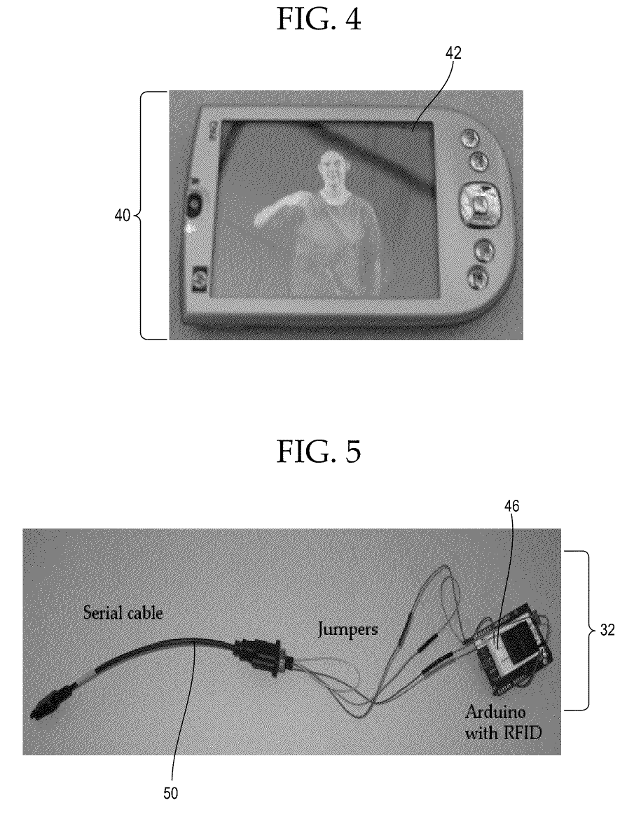

There are various ways to connect the input receiver with the output display. Although one potential interaction is described below, it is not intended to be limiting, and it is understood that those having ordinary skill in the electronics arts would understand how to create systems that connect the input receiver with a memory and an output display with minimal additional effort. As shown in FIG. 4, the initial prototype embodiment of this invention used a PDA as the processor, battery, flash memory, and display screen. The PDA was oriented in the landscape position to support typical video format and for maximum stability. A plastic protective overlay may be applied to the screen 42 to prevent unintentional inputs and to protect the screen from damage or fingerprints. There may also be a “question” or “help” button positioned on the system (e.g., near the screen 42) to help assist a user who is having problems with the system.

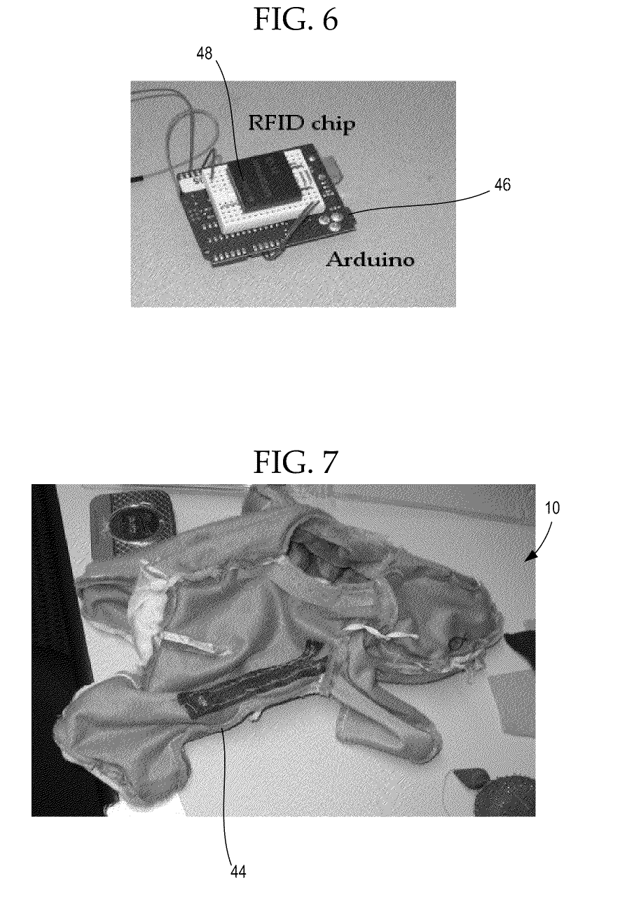

The input receiver 32 may be any appropriate receiver, but in the prototype embodiment, it was an Arduino board 46 with an RFID chip 48. FIGS. 5 and 6 show one embodiment of an input receiver 32 shown as an Arduino board 46 with associated connection mechanisms 50. Connection mechanisms 50 may be used to connect input receiver 32 to memory, processor, and/or output display 40.

As shown in FIG. 7, system 10 may be provided with a closure mechanism 44, such as a zipper, a hook and loop closure, or a snap closure so that administrators can easily remove the screen memory, processor, and/or battery components for replacement, the upload or delete content, or to change system preferences. The memory/processor may be a single component or multiple components. In one embodiment, the memory and/or processor may be removable and programmable, for example, by connecting it to a computer or the internet. In this embodiment, new content, such as games, learning modes, or administrative updates can be uploaded from an external source. Alternative modules could also be purchased separately, along with a new set of object representations 24. It is also be possible to download new object representations 24 on-line.

System 10 may be provided with an on/off switch that is located anywhere on the system 10, such as inside the system (i.e., enclosed by closure mechanism 44), within the system's hand or foot 18, such that depression of the hand or foot activates the on/off switch, or it may be activated once input receiver 32 is activated and then go into silent or sleep mode when not activated for a certain amount of time. Depression of the toy's hand or foot may also be used to switch between various modes. Additionally or alternatively, system 10 may be provided with an accelerometer that “wakes” system from sleep mode when it is shaken or moved, to indicate that it is time to “play.” This feature can be more intuitive to children.

For instance, there may be various different programming modes for interactive system 10. For example, there may a learn mode and a game mode (as well as an administration mode, which is used to set system preferences, upload and delete content, set volume controls, and more). The learn mode and game modes will be described in connection with sign language teaching, although it is understood that appropriate changes may be made in order to convert the learn and game modes to other learning and game situations (such as math problems, learning a foreign language, learning the states and capitals, and so forth.)

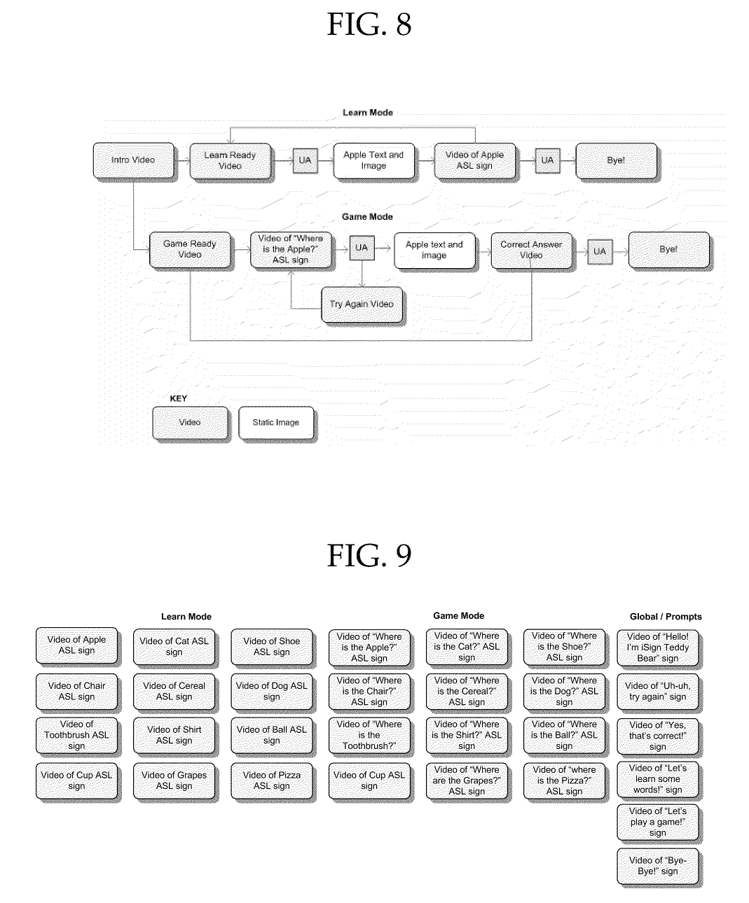

FIGS. 8 and 9 show various examples of learn and game modes. The following example of a child playing with interactive system 10 is provided as a useful summary of the various modes.

Sandy is 4 years old, and was born deaf. Her family is getting ready to go on a trip. Everyone is packed and in the car; Sandy sits in the backseat with her brother, Todd (age 5), who is a child of normal hearing. As they pull onto the interstate for the long trip, Sandy opens her Zoo Pack Flashcards and “shows” the zebra to her interactive system (which, in this example, is referred to as “toy”) by holding it up close to the toy's face or touching it to the toy's head. The light on the toy's head lights up and the LCD comes to life. The same zebra image and text from Sandy's card appear on the screen for a few seconds, and then a smiling woman executes the sign for “zebra,” followed by a small cartoon of a zebra's adventure. Sandy is engaged and quickly finds a card of a lion and “shows” or touches it to the toy. Soon the woman signs the sign for “lion” followed by another short cartoon.

Sandy's brother is also intrigued at this point and has begun watching with her. After each video of the woman signing, she and her brother instinctively imitate—not perfectly, but roughly. Sandy then squeezes Teddy's paw to switch to “game mode.” In this mode, the screen shows a woman signing the question “Where is the cow?” Sandy finds the correct card with the image and text of the word cow on it and shows it to the toy or touches it to the toy's head. “That's right!” the woman signs, followed by a quick cartoon of a cow on a farm.

Without prompting from Sandy, a new puzzle game begins on the screen. The woman performs the sign for “Where is the duck?” Sandy searches and shows the card for “fox” to the bear by mistake. The woman smiles and signs “No, try again.” Sandy is still confused and touches the question mark button next to the screen. The woman then shows the picture for “duck,” followed by the sign of the duck for reinforcement, and followed by a short entertaining cartoon. The scoring mechanism records that Sandy has missed “duck”, updates her progress, and will favor its reappearance in a random-picking algorithm.

On the second day of the trip in the car, Sandy takes the Flashcards out of the toy's backpack and starts puzzle mode again. The smiling woman signs the sign for “Where is the duck?” Suddenly Todd reaches over and hands her the card for “duck.” He has also learned during the time they have been playing together. A scoring mechanism also records Sandy's progress in the game mode. After a few minutes, a live and entertaining “celebration” video plays on the screen.

The game mode may also have more complex or advanced modes that incorporate story-telling and allow users to complete sequence tasks involving daily events, such as getting dressed, going to school, having dinner, building a snowman, and so forth.

Certain embodiments provide systems and methods for providing interactive sign language or other types of instruction through the radio frequency identification of objects and coordinating the identification of the objects with a corresponding output, such as a demonstration of a sign language representation of the object.

Changes and modifications, additions and deletions may be made to the structures and methods recited above and shown in the drawings without departing from the scope or spirit of the invention and the following claims.

What is claimed is:

1. An interactive system, comprising:
(a) a body portion;
(b) an input receiver adapted to detect and recognize a code on an object representation; and
(c) an output display adapted to visually represent interactive content associated with the object representation.

2. The interactive system of claim 1, wherein the system further comprises a microprocessor.

3. The interactive system of claim 1, wherein the object representation is a flashcard.

4. The interactive system of claim 1, wherein the object representation is an array of reference points.

5. The interactive system of claim 1, wherein the object representation comprises an RFID tag.

6. The interactive system of claim 1, wherein the object representation comprises a bar code.

7. The interactive system of claim 1, wherein the input receiver comprises an RFID reader.

8. The interactive system of claim 1, wherein the input receiver comprises a bar code reader.

9. The interactive system of claim 1, wherein the output portion is a screen.

10. The interactive system of claim 1, wherein the content is a video.

11. The interactive system of claim 1, wherein the content is a video display of a sign language gesture.

12. The interactive system of claim 1, wherein the body portion comprises a teddy bear.

13. The interactive system of claim 1, wherein the system further comprises a storage pack.

14. A system for teaching sign language, comprising:
(a) at least one radio frequency identification tag, wherein the tag is physically attached to a visual representation of an object;
(b) an antennae for transmitting and receiving a signal from the tag;
(b) memory for storing a visual representation of a content associated with the object;
(c) a video display;
(d) a processor configured to access the content for the object based on the signal from the tag and cause the content to be displayed on the video display;
(e) a housing for the tag, antennae, memory, video display, and processor.

15. The system of claim 14, wherein the content is a visual representation of a sign language gesture.

16. The system of claim 14, wherein the visual representation of the object is a flash card.

17. The system of claim 14, wherein the visual representation of the object is a three-dimensional representation of the object.

18. The system of claim 14, wherein the video display is an LCD panel.

19. The system of claim 14, wherein the housing is a teddy bear.
